(19) United States
(12) Patent Application Publication
(10) Pub. No.: US 2025/0196495 A1
(43) Pub. Date: Jun. 19, 2025

(54) Liquid Ejection Apparatus

(71) Applicant: SEIKO EPSON CORPORATION, Tokyo (JP)

(72) Inventors: Akira MIYAGISHI, Shiojiri (JP); Asami OKAMOTO, Matsumoto (JP)

(21) Appl. No.: 18/978,555

(22) Filed: Dec. 12, 2024

(30) Foreign Application Priority Data
Dec. 13, 2023 (JP) 2023-209943

(51) Int. Cl. B41J 2/045; B41J 2/14; B41J 2/185

(52) U.S. Cl. CPC B41J 2/04571; B41J 2/04581; B41J 2/04588; B41J 2/14233; B41J 2/185

(57) ABSTRACT

A liquid ejection apparatus includes a first piezoelectric element, a first pressure chamber, a second piezoelectric element, a second pressure chamber, a nozzle flow path which communicates with the first pressure chamber and the second pressure chamber and which is provided with a nozzle, and a determination unit configured to determine a liquid state at the nozzle based on a first detection signal which represents a change in electromotive force of the first piezoelectric element after at least one of the first piezoelectric element and the second piezoelectric element is driven, and a second detection signal which represents a change in electromotive force of the second piezoelectric element after at least another of the first piezoelectric element and the second piezoelectric element is driven.

The present application is based on, and claims priority from JP Application Serial Number 2023-209943, filed Dec. 13, 2023, the disclosure of which is hereby incorporated by reference herein in its entirety.

### BACKGROUND

### 1. Technical Field

The present disclosure relates to a liquid ejection apparatus.

### 2. Related Art

As disclosed in, for example, JP-A-2011-189655, a liquid ejection apparatus represented by an inkjet printer includes nozzles that eject a liquid, pressure chambers for applying pressure to the liquid, and piezoelectric elements that apply pressure to the pressure chambers. In JP-A-2011-189655, when the piezoelectric element is driven, the pressure in the pressure chamber varies, and ink is ejected from the nozzle due to the variation in the pressure.

Further, in the apparatus described in JP-A-2011-189655, the residual vibration waveform based on the vibration of the ink after the drive signal is supplied to each piezoelectric element is detected as the electromotive force of that piezoelectric element, and the presence or absence of abnormality in the ink ejection state is determined based on the detection result.

JP-A-2011-189655 is an example of the related art.

For example, it is conceivable to adopt a configuration in which a plurality of pressure chambers is provided to each nozzle, and a plurality of piezoelectric elements is provided corresponding to the plurality of pressure chambers. In this case, by simultaneously driving the plurality of piezoelectric elements, the pressure in each of the plurality of pressure chambers varies, and the ink is ejected from the one nozzle due to the variation in the pressure. In such a configuration in which the plurality of pressure chambers is provided to each nozzle as described above, there is a problem that the signal represented by the detection result of the electromotive force thus detected is complicated, and it is difficult to determine whether abnormality exists in the ejection state. For this reason, in the related-art apparatus, it is difficult to immediately determine whether there is an abnormality in the ejection state, and it takes certain time for the determination.

### SUMMARY

In order to solve the problems described above, a liquid ejection apparatus according to a preferred aspect of the present disclosure includes a first piezoelectric element driven by a drive signal, a first pressure chamber a volume of which changes in accordance with displacement of the first piezoelectric element, a second piezoelectric element driven by the drive signal, a second pressure chamber a volume of which changes in accordance with displacement of the second piezoelectric element, a nozzle flow path which communicates with the first pressure chamber and the second pressure chamber and which is provided with a nozzle configured to eject a liquid, and a determination unit configured to determine a liquid state at the nozzle based on a difference between a first detection signal which represents a change in electromotive force of the first piezoelectric element in accordance with a residual vibration generated in the liquid in the first pressure chamber after at least one of the first piezoelectric element and the second piezoelectric element is driven, and a second detection signal which represents a change in electromotive force of the second piezoelectric element in accordance with a residual vibration generated in the liquid in the second pressure chamber after at least another of the first piezoelectric element and the second piezoelectric element is driven.

### BRIEF DESCRIPTION OF THE DRAWINGS

FIG. 1 is a schematic diagram illustrating a configuration example of a liquid ejection apparatus according to a first embodiment.

FIG. 2 is a block diagram showing an electrical configuration of the liquid ejection apparatus according to the first embodiment.

FIG. 3 is a schematic diagram of a flow path in a liquid ejection head according to the first embodiment.

FIG. 4 is a diagram corresponding to a cross-sectional surface along the line A-A in FIG. 3.

FIG. 5 is a diagram illustrating a configuration example of a drive controller in the first embodiment.

FIG. 6 is a diagram illustrating a waveform provided to a drive signal in the first embodiment.

FIG. 7 is a diagram illustrating an ejection operation and a detection operation in the first embodiment.

FIG. 8 is a diagram illustrating a detection circuit and a determination unit shown in FIG. 2.

FIG. 9 is a diagram showing a first detection signal and a second detection signal in a normal state.

FIG. 10 is a diagram showing a determining signal that is a signal related to a difference between the first detection signal and the second detection signal shown in FIG. 9.

FIG. 11 is a diagram showing the first detection signal and the second detection signal in an abnormal state.

FIG. 12 is a diagram showing a determining signal that is a signal related to a difference between the first detection signal and the second detection signal shown in FIG. 11.

FIG. 13 is a diagram showing a configuration example of a drive circuit of a comparative example.

FIG. 14 is a diagram showing a determining signal in a normal state in the comparative example.

FIG. 15 is a diagram showing a determining signal in an abnormal state in the comparative example.

FIG. 16 is a diagram showing a determination unit in a second embodiment.

FIG. 17 is a diagram showing a determination unit in a third embodiment.

FIG. 18 is a diagram showing a configuration example of a drive controller and a head chip in a fourth embodiment.

### DESCRIPTION OF EMBODIMENTS

Some preferred embodiments according to the present disclosure will hereinafter be described with reference to the accompanying drawings. Note that in the drawings, dimensions and scales of components are different from the actual ones as appropriate and some portions are schematically illustrated in order to facilitate understanding. Further, the scope of the present disclosure is not limited to these embodiments unless particularly described to limit the present disclosure in the following description.

Note that in the following description, an X axis, a Y axis, and a Z axis crossing each other are used as appropriate. Further, a direction along the X axis is referred to as an X1 direction, and a direction opposite to the X1 direction is referred to as an X2 direction. Similarly, directions opposite to each other along the Y axis are referred to as a Y1 direction and a Y2 direction. Further, directions opposite to each other along the Z axis are referred to as a Z1 direction and a Z2 direction. Typically, the Z axis is a vertical axis, and the Z2 direction corresponds to a downward direction in the vertical direction. However, the Z axis is not required to be a vertical axis. Further, the X axis, the Y axis, and the Z axis are typically orthogonal to each other, but are not limited thereto, and sufficiently cross each other at an angle in a range, for example, no smaller than 80° and no larger than 100°.

### A: First Embodiment

### A1: Overall Configuration of Liquid Ejection Apparatus

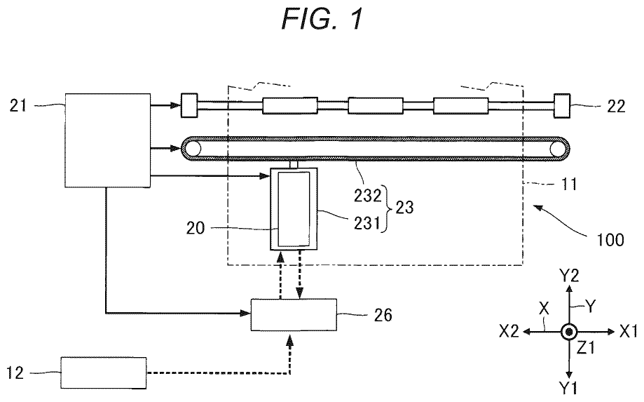

FIG. 1 is a schematic diagram illustrating a configuration example of a liquid ejection apparatus 100 according to the embodiment. The liquid ejection apparatus 100 is an inkjet printer that ejects a liquid such as ink onto a medium 11 as droplets. The medium 11 is, for example, printing paper. Note that the medium 11 is not limited to the printing paper, and may be a printing target made of any materials such as a resin film or fabric.

As illustrated in FIG. 1, the liquid ejection apparatus 100 includes a liquid container 12, a control unit 21, a conveyance mechanism 22, a moving mechanism 23, a liquid ejection head 20, and a circulation mechanism 26.

The liquid container 12 stores ink. Specific examples of the liquid container 12 include a cartridge detachably attached to the liquid ejection apparatus 100, an ink pack shaped like a bag formed of a flexible film, and an ink tank to which the ink can be replenished. Note that any type of ink may be stored in the liquid container 12.

The control unit 21 controls the operation of each element of the liquid ejection apparatus 100. The control unit 21 includes, for example, a single processing circuit or a plurality of processing circuits such as a central processing unit (CPU) or a field programmable gate array (FPGA), and a single storage circuit or a plurality of storage circuits such as a semiconductor memory device.

The conveyance mechanism 22 conveys the medium 11 in the Y1 direction under the control of the control unit 21. The moving mechanism 23 reciprocates the liquid ejection head 20 along the X axis under the control of the control unit 21. The moving mechanism 23 includes a carriage 231 having a substantially boxlike shape that houses the liquid ejection head 20, and an endless conveyance belt 232 to which the carriage 231 is fixed. Note that the number of the liquid ejection heads 20 mounted on the carriage 231 is not limited to one and may be two or more. Further, in addition to the liquid ejection head 20, the liquid container 12 described above may be mounted on the carriage 231.

The liquid ejection head 20 ejects the ink supplied from the liquid container 12 to the medium 11 from each of the plurality of nozzles under the control of the control unit 21 based on print data Img. By the ejection being performed in parallel to the conveyance of the medium 11 by the conveyance mechanism 22 and the reciprocation of the liquid ejection head 20 by the moving mechanism 23, an image corresponding to the print data Img with the ink is formed on a surface of the medium 11.

The liquid container 12 is coupled to the liquid ejection head 20 via the circulation mechanism 26. The circulation mechanism 26 is a mechanism that supplies the ink to the liquid ejection head 20 and collects the ink ejected from the liquid ejection head 20 in order to supply the ink again to the liquid ejection head 20 under the control of the control unit 21. Due to the operation of the circulation mechanism 26, it is possible to suppress an increase in the viscosity of the ink or to reduce stagnation of bubbles in the ink.

### A2: Electrical Configuration of Liquid Ejection Apparatus

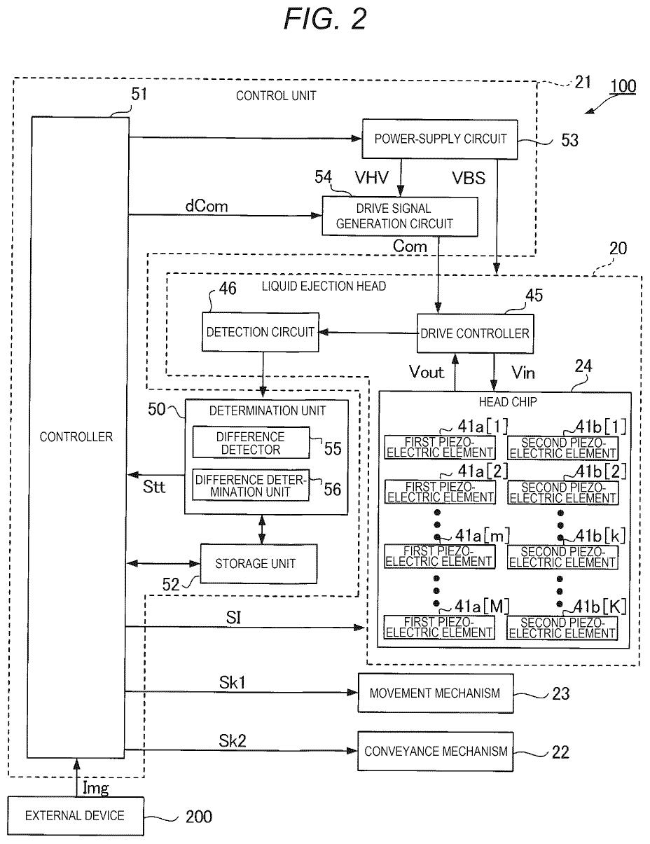

FIG. 2 is a block diagram showing an electrical configuration of the liquid ejection apparatus 100 according to the first embodiment.

As shown in FIG. 2, the liquid ejection head 20 includes a head chip 24, a drive controller 45, and a detection circuit 46.

The head chip 24 includes a plurality of piezoelectric elements 41. Specifically, the head chip 24 includes M first piezoelectric elements 41a to be driven by a drive signal Com and K second piezoelectric elements 41b to be driven by the drive signal Com. One nozzle N is provided for a set of one first piezoelectric element 41a and one second piezoelectric element 41b. Each of the piezoelectric elements 41 has a function of applying pressure to the ink and a function of receiving pressure from the ink and outputting a detection signal Vout.

Note that in the following description, the first piezoelectric element 41a and the second piezoelectric element 41b are also simply referred to as “piezoelectric elements 41” when not particularly distinguished from each other. Further, in the following description, in order to distinguish each of the M first piezoelectric elements 41a, the first piezoelectric element 41a may be referred to as a first piezoelectric element 41a[m] using an additional character [m] in some cases. M is a natural number equal to or greater than 1, and m is a natural number no smaller than 1 and no larger than M. Further, the additional letter [m] may be used in an element or a signal corresponding to the first piezoelectric element 41a[m] to express a correspondence relationship with the first piezoelectric element 41a[m] in some cases. Similarly, in order to distinguish the K second piezoelectric elements 41b from each other, the second piezoelectric element 41b may be referred to as a second piezoelectric element 41b[k] using an additional letter [k] in some cases. K is a natural number of no smaller than 1, and k is a natural number no smaller than 1 and no larger than K. Further, the additional letter [k] may be used in an element t or a signal corresponding to the second piezoelectric element 41b[k] to express a correspondence relationship with the second piezoelectric element 41b[k] in some cases.

The drive controller 45 drives the piezoelectric elements 41 under the control of the control unit 21. Further, the drive controller 45 also serves as a switching circuit. Specifically, the drive controller 45 controls supply of the drive signal Com to each of the M first piezoelectric elements 41a and the K second piezoelectric elements 41b. The drive controller 45 switches whether to supply the drive signal Com to the piezoelectric element 41 as a supply drive signal Vin. Further, the drive controller 45 switches whether to supply the detection circuit 46 with the electromotive force in each of the M first piezoelectric elements 41a and the K second piezoelectric elements 41b as the detection signal Vout.

The detection circuit 46 applies a bias to the detection signal Vout representing a change in the electromotive force of each of the piezoelectric elements 41 due to the residual vibration caused by the drive of that piezoelectric element 41. The residual vibration is a pressure vibration that remains in the ink located in the pressure chamber C after the volume of the pressure chamber C changes due to the drive of the piezoelectric element 41.

As shown in FIG. 2, the control unit 21 includes a controller 51, a storage unit 52, a power-supply circuit 53, a drive signal circuit generation 54, and a determination unit 50.

The controller 51 has a function of controlling the operation of each unit of the liquid ejection apparatus 100 and a function of processing various types of data. The controller 51 controls the operations of the drive controller 45 and the detection circuit 46 described above. The controller 51 includes a processor such as one or more central processing units (CPUs). Note that instead of, or in addition to the CPU, the controller 51 may include a programmable logic device such as a field-programmable gate array (FPGA) in addition to the CPU. Further, when the controller 51 is configured with a plurality of processors, for example, control of an operation of the drive controller 45 and control of an operation of the detection circuit 46 may be performed by respective processors separate from each other. Further, when the controller 51 is configured with a plurality of processors, the plurality of processors may be mounted on respective boards or the like different from each other.

The storage unit 52 stores various programs to be executed by the controller 51 and various types of data such as the print data Img to be processed by the controller 51. The storage unit 52 includes a semiconductor memory of one or both of a volatile memory such as a random access memory (RAM), and a nonvolatile memory such as an electrically erasable programmable read only memory (EEPROM) or a programmable ROM (PROM). The print data Img is supplied from an external device 200 such as a personal computer or a digital camera. Further, the storage unit 52 stores the detection signal Vout. Note that the storage unit 52 may be configured as a part of the controller 51.

The power-supply circuit 53 is supplied with power from a commercial power supply (not shown) to generate predetermined various potentials. The various potentials thus generated are appropriately supplied to the units of the liquid ejection apparatus 100. For example, the power-supply circuit 53 generates a power supply potential VHV and an offset potential VBS. The offset potential VBS is supplied to the liquid ejection head 20. Further, the power supply potential VHV is supplied to the drive signal generation circuit 54.

The drive signal generation circuit 54 is a circuit that generates the drive signals Com for driving the respective piezoelectric elements 41. Specifically, the drive signal generation circuit 54 includes, for example, DA conversion circuits and amplifier circuits. In the drive signal generation circuit 54, the DA conversion circuit converts the waveform designation signal dCom from the controller 51 from a digital signal to an analog signal, and the amplifier circuit amplifies the analog signal using the power supply potential VHV from the power-supply circuit 53 to thereby generate the drive signal Com. A signal having a waveform actually supplied to the piezoelectric element 41 out of the waveforms the drive signal Com includes corresponds to the supply drive signal Vin described above. The waveform designation signal dCom is a digital signal for defining the waveform of the drive signal Com.

The determination unit 50 determines a liquid state which is an ejection state of the ink from the nozzle N. Specifically, the determination unit 50 determines the liquid state based on the detection signal Vout, and generates determination information Stt representing the determination result. The determination information Stt is used for, for example, ejection control of the ink from the nozzle during printing. Specifically, the determination information Stt is used for, for example, correction of the drive signal Com. Note that the determination unit 50 may be configured as a part of the controller 51. Further, a part or whole of the determination unit 50 may be provided to the liquid ejection head 20.

In the control unit 21 described hereinabove, the controller 51 executes the program stored in the storage unit 52 to thereby control the operations of the units of the liquid ejection apparatus 100. The controller 51 generates the control signals Sk1 and Sk2, the control signal SI, and the waveform designation signal dCom as signals for controlling the operations of the unit of the liquid ejection apparatus 100 due to the execution of the program.

The control signal Sk2 is a signal for controlling the drive of the conveyance mechanism 22. The control signal Sk1 is a signal for controlling the drive of the moving mechanism 23. The control signal SI is a digital signal for designating an operation state of the piezoelectric element 41. Note that the control signal SI includes a latch signal LAT and a change signal CH which are timing signals for defining the drive timing of the piezoelectric element 41. The timing signals are generated based on, for example, an output of an encoder that detects the position of the carriage 231 described above.

### A3: Flow Path of Liquid Ejection Head

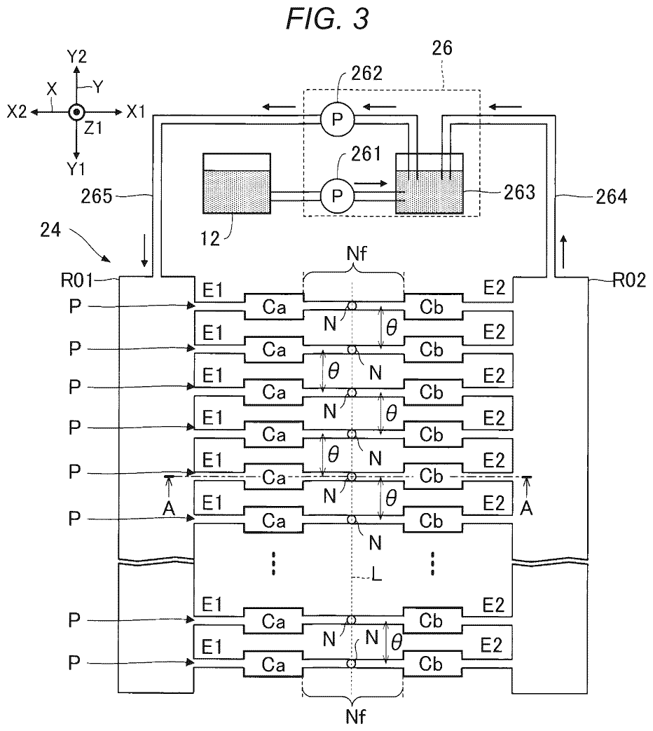

FIG. 3 is a schematic diagram of a flow path in the head chip 24 related to the first embodiment. As shown in FIG. 3, the head chip 24 is provided with a plurality of nozzles N, a plurality of individual flow paths P, a first common liquid chamber R01, and a second common liquid chamber R02.

The plurality of nozzles N is arranged along the Y axis. Each of the nozzles N ejects the ink in the Z2 direction. A set of the nozzles N forms a nozzle array L. Further, the nozzles N are arranged at regular intervals at a pitch θ. The pitch θ is a distance between the centers of the nozzles N in a direction along the Y axis. The individual flow paths P communicate with the respective nozzles N. The individual flow paths P extend along the X axis and communicate with the respective nozzles N different from each other. Further, the plurality of individual flow paths P is arranged along the Y axis.

Each of the individual flow paths P includes a first pressure chamber Ca, a second pressure chamber Cb, and a nozzle flow path Nf. Each of the first pressure chamber Ca and the second pressure chamber Cb in each of the individual flow paths P is a space which extends along the X axis and in which the ink to be ejected from the nozzle N is stored. The first pressure chamber Ca is provided for each of the first piezoelectric elements 41a. The plurality of first pressure chambers Ca is arranged along the Y axis. Each of the first pressure chambers Ca changes the volume in accordance with a displacement of the first piezoelectric element 41a. Similarly, the second pressure chamber Cb is provided for each of the second piezoelectric elements 41b. The plurality of second pressure chambers Cb is arranged along the Y axis. Each of the second pressure chambers Cb changes the volume in accordance with the displacement of the second piezoelectric element 41b.

Note that in each of the individual flow paths P, the positions of the first pressure chamber Ca and the second pressure chamber Cb in a direction along the Y axis are the same in the example shown in FIG. 3. The expression “two things are the same” includes when the two things can be assumed to be the same taking an error in the measurement into consideration in addition to when the two things are completely the same. Further, the first pressure chamber Ca and the second pressure chamber Cb are hereinafter simply referred to as “pressure chambers C” when they are not particularly distinguished from each other. Further, a set of one first pressure chamber Ca and one second pressure chamber Cb communicates with one nozzle N via the nozzle flow path Nf.

The nozzle flow path Nf is disposed between the first pressure chamber Ca and the second pressure chamber Cb in each of the individual flow paths P. In each of the individual flow paths P, the nozzle flow path Nf mainly extends along the X axis and communicates with the first pressure chamber Ca and the second pressure chamber Cb. Each of the nozzle flow paths Nf is provided with the nozzle N for ejecting the ink. Further, the plurality of nozzle flow paths Nf is arranged at intervals along the Y axis. In each of the nozzle flow paths Nf, the ink is ejected from the nozzle N by changing the pressure in the first pressure chamber Ca and the second pressure chamber Cb described above.

The first common liquid chamber R01 and the second common liquid chamber R02 communicate with the plurality of individual flow paths P. Each of the first common liquid chamber R01 and the second common liquid chamber R02 is a space extending along the Y axis over the entire range in which the nozzles N are distributed. When viewed in a direction along the Z axis, the plurality of individual flow paths P and the plurality of nozzles N described above are located between the first common liquid chamber R01 and the second common liquid chamber R02. Note that viewing something in a direction along the Z axis is hereinafter referred to as a “plan view” of that thing.

The first common liquid chamber R01 is coupled to an end portion E1 in the X2 direction of each of the individual flow paths P. The ink to be supplied to each of the individual flow paths P is stored in the first common liquid chamber R01. Meanwhile, the second common liquid chamber R02 is coupled to the end portion E2 in the X1 direction of each of the individual flow paths P. In the second common liquid chamber R02, the ink which is not subjected to the ejection but is discharged from each of the individual flow paths P is stored.

The circulation mechanism 26 is coupled to the first common liquid chamber R01 and the second common liquid chamber R02. The circulation mechanism 26 is a mechanism which supplies the ink to the first common liquid chamber R01, and which collects the ink discharged from the second common liquid chamber R02 in order to supply the ink to the first common liquid chamber R01 again. The circulation mechanism 26 includes a first supply pump 261, a second supply pump 262, a storage container 263, a collection flow path 264, and a supply flow path 265.

The first supply pump 261 is a pump that supplies the ink stored in the liquid container 12 to the storage container 263. The storage container 263 is a sub-tank that temporarily stores the ink supplied from the liquid container 12. The collection flow path 264 is a flow path through which the second common liquid chamber R02 and the storage container 263 communicate with each other, and which collects the ink from the second common liquid chamber R02 into the storage container 263. The ink stored in the liquid container 12 is supplied from the first supply pump 261 to the storage container 263, and in addition, the ink discharged from each of the individual flow paths P to the second common liquid chamber R02 is supplied to the storage container 263 via the collection flow path 264. The second supply pump 262 is a pump that sends the ink stored in the storage container 263. The supply flow path 265 is a flow path through which the first common liquid chamber R01 and the storage container 263 communicate with each other, and which supplies the ink from the storage container 263 to the first common liquid chamber R01.

### A4: Specific Structure of Liquid Ejection Head

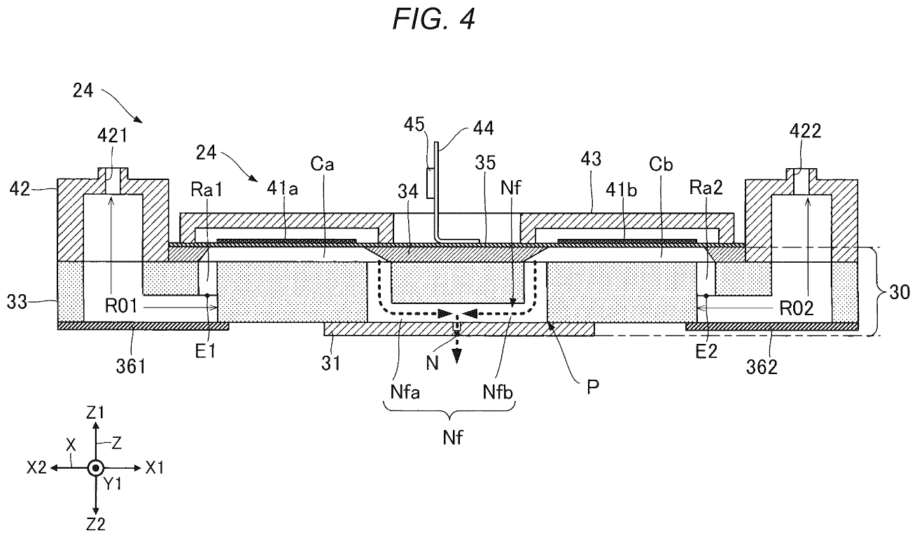

FIG. 4 is a diagram corresponding to a cross-sectional surface along the line A-A in FIG. 3. In FIG. 4, there is shown a cross-sectional surface of the head chip 24 cut along a plane parallel to the X axis and the Z axis along the individual flow path P. As shown in FIG. 4, the head chip 24 includes a flow path structure 30, the plurality of piezoelectric elements 41, a housing unit 42, a protective substrate 43, and a wiring board 44.

The flow path structure 30 is provided with the first common liquid chamber R01, the second common liquid chamber R02, the plurality of individual flow paths P, and the plurality of nozzles N all described above. Specifically, the flow path structure 30 is a structure in which a nozzle substrate 31, a communication plate 33, a pressure chamber substrate 34, and a vibrating plate 35 are stacked in this order toward the Z1 direction. The members, namely the nozzle substrate 31, the communication plate 33, the pressure chamber substrate 34, and the vibrating plate 35, extend along the Y axis, and are each manufactured by processing a silicon single-crystal plate using, for example, a semiconductor processing technique. Further, these members are bonded to each other with an adhesive or the like. Note that another layer or substrate such as an adhesive layer may be appropriately interposed between two adjacent members out of the plurality of members constituting the flow path structure 30.

The nozzle substrate 31 is provided with the plurality of nozzles N. Each of the nozzles N is a through hole which penetrates the nozzle substrate 31 and through which the ink passes.

The communication plate 33 is provided with a part of the first common liquid chamber R01, a part of the second common liquid chamber R02, and portions of the plurality of individual flow paths P excluding the first pressure chambers Ca and the second pressure chambers Cb. Each of the individual flow paths P includes a supply flow path Ra1 and a discharge flow path Ra2 in addition to the first pressure chamber Ca, the second pressure chamber Cb, and the nozzle flow path Nf. Out of such elements constituting the individual flow path P, the nozzle flow path Nf, the supply flow path Ra1, and the discharge flow path Ra2 are provided to the communication plate 33.

A part of each of the first common liquid chamber R01 and the second common liquid chamber R02 is a space penetrating the communication plate 33. On a surface of the communication plate 33 facing to the Z2 direction, a vibration absorber 361 and a vibration absorber 362 that close openings due to those spaces are installed.

Each of the vibration absorber 361 and the vibration absorber 362 is a layered member made of an elastic material. The vibration absorber 361 forms a part of a wall surface of the first common liquid chamber R01, and absorbs pressure fluctuation in the first common liquid chamber R01. Similarly, the vibration absorber 362 forms a part of a wall surface of the second common liquid chamber R02 and absorbs pressure fluctuation in the second common liquid chamber R02.

As described above, the nozzle flow path Nf is a space through which the first pressure chamber Ca and the second pressure chamber Cb communicate with each other. In the example shown in FIG. 4, the nozzle flow path Nf has a flow path Nfa from the first pressure chamber Ca to the nozzle N and a flow path Nfb from the second pressure chamber Cb to the nozzle N. Each of the flow paths Nfa and Nfb is a space extending along the Z axis, and then extending along the X axis.

Each of the supply flow path Ra1 and the discharge flow path Ra2 is a space which extends along the Z axis and penetrates the communication plate 33. The first common liquid chamber R01 and the first pressure chamber Ca communicate with each other through the supply flow path Ra1, and the ink from the first common liquid chamber R01 is supplied to the first pressure chamber Ca through the supply flow path Ra1. One end of the supply flow path Ra1 opens on a surface of the communication plate 33 facing to the Z1 direction. On the other hand, the other end of the supply flow path Ra1 is the end portion E1 at the upstream of the individual flow path P. Meanwhile, the second common liquid chamber R02 and the second pressure chamber Cb communicate with each other through the discharge flow path Ra2, and the ink from the second pressure chamber Cb is discharged to the second common liquid chamber R02 through the discharge flow path Ra2. One end of the discharge flow path Ra2 opens on a surface of the communication plate 33 facing to the Z1 direction. In contrast, the other end of the discharge flow path Ra2 is the end portion E2 at the downstream of the individual flow path P.

The pressure chamber substrate 34 is provided with first pressure chambers Ca and second pressure chambers Cb of the plurality of individual flow paths P. Each of the first pressure chambers Ca and the second pressure chambers Cb is a gap between the communication plate 33 and the vibrating plate 35 which penetrates the pressure chamber substrate 34.

The vibrating plate 35 is a plate-like member that can elastically vibrate. The vibrating plate 35 is, for example, a laminated body including a first layer made of silicon oxide (SiO₂) and a second layer made of zirconium oxide (ZrO₂). Another layer made of a metal oxide or the like may be interposed between the first layer and the second layer. Note that a part or whole of the vibrating plate 35 may be integrally formed of the same material as that of the pressure chamber substrate 34. For example, the vibrating plate 35 and the pressure chamber substrate 34 can be integrally formed by selectively removing a part in the thickness direction of the region corresponding to the pressure chamber C in the plate-like member having a predetermined thickness. Further, the vibrating plate 35 may be formed of a layer of a single material.

The plurality of piezoelectric elements 41 corresponding to the pressure chambers C different from each other is installed on the surface facing to the Z1 direction of the vibrating plate 35. Specifically, the first piezoelectric element 41a corresponding to each of the first pressure chambers Ca and the second piezoelectric element 41b corresponding to each of the second pressure chambers Cb are provided. The first piezoelectric element 41a overlaps the first pressure chamber Ca in the plan view. The second piezoelectric element 41b overlaps the second pressure chamber Cb in the plan view.

Each of the piezoelectric elements 41 is formed by stacking, for example, two electrodes opposed to each other and a piezoelectric layer disposed between the two electrodes. Each of the piezoelectric elements 41 changes the pressure of the ink in the pressure chamber C to thereby eject the ink in the pressure chamber C from the nozzle N. When the drive signal Com is supplied to the piezoelectric element 41, the piezoelectric element 41 vibrates the vibrating plate 35 in accordance with its own deformation. When the pressure chamber C expands and contracts due to this vibration, the pressure of the ink in the pressure chamber C varies.

The housing unit 42 is a case for storing the ink. The housing unit 42 is provided with a space constituting the rest of the first common liquid chamber R01 and the second common liquid chamber R02 except portions provided to the communication plate 33. Further, the housing unit 42 is provided with a supply port 421 and a discharge port 422. The supply port 421 is a pipe line communicating with the first common liquid chamber R01, and is coupled to the supply flow path 265 of the circulation mechanism 26. Therefore, the ink sent from the second supply pump 262 to the supply flow path 265 is supplied to the first common liquid chamber R01 via the supply port 421. On the other hand, the discharge port 422 is a pipe line communicating with the second common liquid chamber R02, and is coupled to the collection flow path 264 of the circulation mechanism 26. Therefore, the ink in the second common liquid chamber R02 is discharged to the collection flow path 264 via the discharge port 422.

The protective substrate 43 is a plate-like member installed on the surface facing to the Z1 direction of the vibrating plate 35, and protects the plurality of piezoelectric elements 41 and reinforces the mechanical strength of the vibrating plate 35. A space for housing the plurality of piezoelectric elements 41 is formed between the protective substrate 43 and the vibrating plate 35.

The wiring board 44 is mounted on a surface facing to the Z1 direction of the vibrating plate 35 and is a mounted component for electrically coupling the control unit 21 and the head chip 24 to each other. For example, the wiring board 44 having flexibility such as a flexible printed circuit (FPC) or a flexible flat cable (FFC) is preferably used. The drive controller 45 described above is mounted on the wiring board 44. Note that in addition to the drive controller 45, the detection circuit 46 described above may be mounted on the wiring board 44.

The drive controller 45 is located between the first piezoelectric element 41a and the second piezoelectric element 41b when viewed in the 22 direction which is the ejection direction of the ink from the nozzle N. Therefore, the supply path of the drive signal Com to both the first piezoelectric element 41a and the second piezoelectric element 41b from the drive controller 45 can be shortened compared to a configuration in which the drive controller 45 is located at other positions.

In the head chip 24 having the configuration described above, when the first piezoelectric element 41a and the second piezoelectric element 41b are driven simultaneously due to the supply of the drive signal Com, the pressure in the first pressure chamber Ca and the pressure in the second pressure chamber Cb are varied, and the ink is ejected from the nozzle N in accordance with the pressure variation. In FIG. 4, the path and the direction of the flow of ink when the first piezoelectric element 41a and the second piezoelectric element 41b are driven simultaneously are indicated by the dashed arrows.

Further, in the head chip 24, the ink flows through the first common liquid chamber R01, the supply flow path Ra1, the first pressure chamber Ca, the nozzle flow path Nf, the second pressure chamber Cb, the discharge flow path Ra2, and the second common liquid chamber R02 in this order due to the operation of the circulation mechanism 26 described above. Note that the operation period or the operation timing of the circulation mechanism 26 are not limited, and whether the operation period or the operation timing of the circulation mechanism 26 overlap the period or the timing of ejecting the ink from the nozzle N is also not limited.

By providing the circulation mechanism 26, it is possible to reduce the accumulation of the ink in the flow path between the supply flow path Ra1 and the discharge flow path Ra2. Therefore, the increase in viscosity of the ink and the precipitation of the component in the vicinity of the nozzle N can be reduced. As a result, it is possible to prevent deterioration of the ejection characteristics such as the ejection amount or the ejection speed of the ink in the head chip 24.

Note that the coupling configuration between the circulation mechanism 26 and the head chip 24 may be reversed between the supply side and the discharge side with respect to the coupling configuration described above. In this case, the supply flow path Ra1 functions as a discharge flow path through which the ink is discharged from the first pressure chamber Ca, and the discharge flow path Ra2 functions as a supply flow path through which the ink is supplied to the second pressure chamber Cb.

### A5: Details of Drive Controller 45

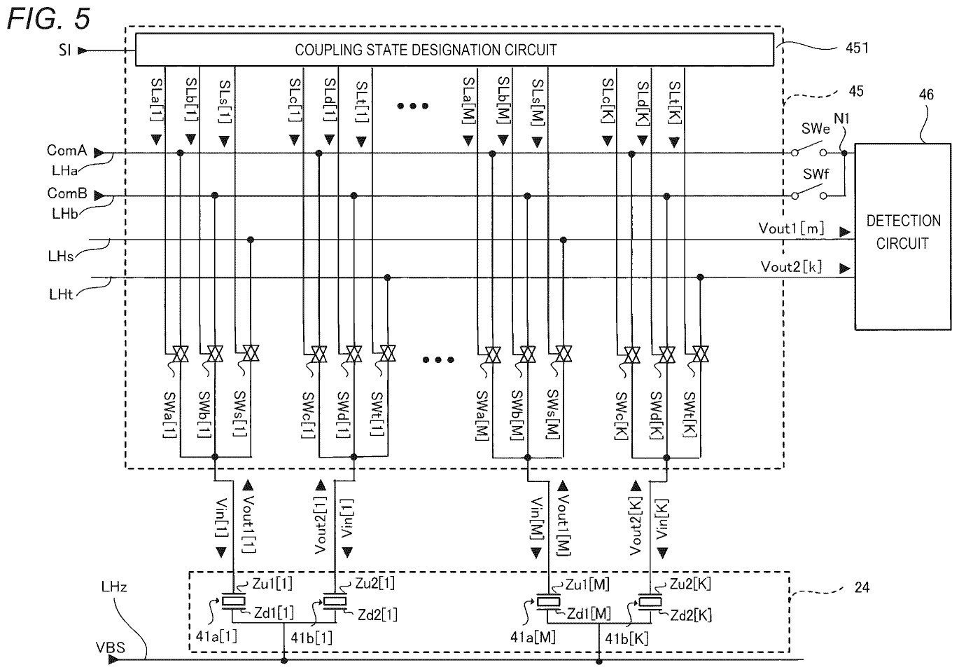

FIG. 5 is a diagram illustrating a configuration example of the drive controller 45 according to the first embodiment. The drive controller 45 supplies the drive signal Com to the piezoelectric element 41 as the supply drive signal Vin. In FIG. 5, one of the two electrodes of the first piezoelectric element 41a[m] is expressed as a first electrode Zu1[m], and the other thereof is expressed as a second electrode Zd1[m]. One of the two electrodes of the second piezoelectric element 41b[k] is expressed as the first electrode Zu2[k], and the other thereof is expressed as the second electrode Zd2[k].

Further, in the example illustrated in FIG. 5, the drive signal Com includes a first drive signal ComA related to the ejection of the ink and a second drive signal ComB related to a micro vibration of the ink inside the nozzle N. Further, the detection signal Vout includes a first detection signal Vout1 and a second detection signal Vout2.

As shown in FIG. 5, wiring lines LHz, LHa, LHb, LHs, and LHt are coupled to the drive controller 45. Further, the wiring lines LHs and LHt are coupled to the determination unit 50 via the detection circuit 46. The wiring line LHz is a power supply line through which the offset potential VBS is supplied. The wiring line LHa is a signal line for transmitting the first drive signal ComA. The wiring line LHb is a signal line for transmitting the second drive signal ComB. The wiring line LHs is a signal line for transmitting the first detection signal Vout1. The wiring line LHt is a signal line for transmitting the second detection signal Vout2.

The drive controller 45 includes a plurality of switches SW and a coupling state designation circuit 451 that designates coupling states of the plurality of switches. The plurality of switches SW includes M switches SWa (SWa[1] to SWa[M]), M switches SWb (SWb[1] to SWb[M]), K switches SWc (SWc[1] to SWd[K]), K switches SWd (SWd[1] to SWd[K]), M switches SWs (SWs[1] to SWs[M]), and K switches SWt (SWt[1] to SWt[K]). Each of the switches SW is, for example, a transmission gate.

The switch SWa[m] is a switch that switches between conduction (ON) and non-conduction (OFF) between the wiring line LHa for the transmission of the first drive signal ComA and the first piezoelectric element 41a[m]. The switch SWb[m] is a switch that switches between conduction (ON) and non-conduction (OFF) between the wiring line LHb for the transmission of the second drive signal ComB and the first piezoelectric element 41a[m]. The switch SWc[k] is a switch that switches between conduction (ON) and non-conduction (OFF) between the wiring line LHa for the transmission of the first drive signal ComA and the second piezoelectric element 41b[k]. The switch SWd[k] is a switch that switches between conduction (ON) and non-conduction (OFF) between the wiring line LHb for the transmission of the second drive signal ComB and the second piezoelectric element 41b[k]. The switch SWs[m] is a switch that switches between conduction (ON) and non-conduction (OFF) between the wiring line LHs for the transmission of the first detection signal Vout1 and the first piezoelectric element 41a[m]. The switch SWt[k] is a switch that switches between conduction (ON) and non-conduction (OFF) between the wiring line LHt for the transmission of the second detection signal Vout2 and the second piezoelectric element 41b[k]. In addition, the following is noted.

The first piezoelectric element 41a and the second piezoelectric element 41b are electrically coupled to the wiring line LHa via respective wiring lines different from each other. Similarly, the first piezoelectric element 41a and the second piezoelectric element 41b are electrically coupled to the wiring line LHb via respective wiring lines different from each other. Further, the first piezoelectric element 41a and the second piezoelectric element 41b are electrically coupled to the wiring line LH for transmitting the detection signals Vout different from each other.

The coupling state designation circuit 451 generates the coupling state designation signal SL that designates the on/off state of each of the switches SW based on the control signal SI. The coupling state designation signal SL includes the coupling state designation signals SLa[m], SLb [m], SLc[k], SLd[k], SLs[m], and SLt[k].

The coupling state designation signal SLa[m] is a signal that designates the on/off state of the switch SWa[m]. The switch SWa[m] is set to an ON state when the coupling state designation signal SLa[m] is at a high level, and is set to an OFF state when the coupling state designation signal SLa[m] is at a low level. The drive controller 45 switches the on/off state of the switch SWa[m] to thereby switch whether to supply a part or whole of the waveform provided to the first drive signal ComA to the first piezoelectric element 41a[m] as the supply drive signal Vin.

The coupling state designation signal SLb[m] is a signal which designates the on/off state of the switch SWb[m]. The switch SWb[m] is set to the ON state when the coupling state designation signal SLb[m] is at the high level, and is set to the OFF state when the coupling state designation signal SLb[m] is at the low level. The drive controller 45 switches the on/off state of the switch SWb[m] to thereby switch whether to supply a part or whole of the waveform provided to the second drive signal ComB to the first piezoelectric element 41a[m] as the supply drive signal Vin.

The coupling state designation signal SLc[k] is a signal which designates the on/off state of the switch SWc[k]. The switch SWc[k] is set to the ON state when the coupling state designation signal SLc[k] is at the high level, and is set to the OFF state when the coupling state designation signal SLc[k] is at the low level. The drive controller 45 switches the on/off state of the switch SWc[m] to thereby switch whether to supply a part or whole of the waveform provided to the first drive signal ComA to the second piezoelectric element 41b[k] as the supply drive signal Vin.

The coupling state designation signal SLd[k] is a signal which designates the on/off state of the switch SWd[k]. The switch SWd[k] is set to the ON state when the coupling state designation signal SLd[k] is at the high level, and is set to the OFF state when the coupling state designation signal SLd[k] is at the low level. The drive controller 45 switches the on/off state of the switch SWd[k] to thereby switch whether to supply a part or whole of the waveform provided to the second drive signal ComB to the second piezoelectric element 41b[k] as the supply drive signal Vin.

The coupling state designation signal SLs[m] is a signal which designates the on/off state of the switch SWs[m]. The switch SWs[m] is set to the ON state when the coupling state designation signal SLs[m] is at the high level, and is set to the OFF state when the coupling state designation signal SLs[m] is at the low level. The drive controller 45 switches the on/off state of the switch SWs[m] to thereby switch whether to set the state in which the first detection signal Vout1 can be detected from the first piezoelectric element 41a[m].

The coupling state designation signal SLt[k] is a signal which designates the on/off state of the switch SWt[k]. The switch SWt[k] is set to the ON state when the coupling state designation signal SLt[k] is at the high level, and is set to the OFF state when the coupling state designation signal SLt[k] is at the low level. The drive controller 45 switches the on/off state of the switch SWt[k] to thereby switch whether to set the state in which the second detection signal Vout2 can be detected from the second piezoelectric element 41b[k].

In the present embodiment, a period in which the switch SWa[m] is in the ON state, a period in which the switch SWb[m] is in the ON state, and a period in which the switch SWs[m] is in the ON state do not overlap each other. Similarly, a period in which the switch SWc[k] is in the ON state, a period in which the switch SWd[k] is in the ON state, and a period in which the switch SWt[k] is in the ON state do not overlap each other. Further, in the present embodiment, the period in which the switch SWa[m] is in the ON state and the period in which the switch SWc[k] is in the ON state overlap each other. The period in which the switch SWb[m] is in the ON state and the period in which the switch SWd[k] is in the ON state overlap each other. The period in which the switch SWs[m] is in the ON state and the period in which the switch SWt[k] is in the ON state overlap each other.

When the switch SWa[m] and the switch SWc[k] are simultaneously turned ON and the same first drive signal ComA is supplied to the first piezoelectric element 41a and the second piezoelectric element 41b, the first piezoelectric element 41a and the second piezoelectric element 41b are driven simultaneously. As a result, the pressure in the first pressure chamber Ca and the pressure in the second pressure chamber Cb vary, and the ink is ejected from the nozzle N. Further, when the switch SWb[m] and the switch SWd[k] are simultaneously turned ON and the same second drive signal ComB is supplied to the first piezoelectric element 41a and the second piezoelectric element 41b, the first piezoelectric element 41a and the second piezoelectric element 41b are simultaneously driven to make the micro vibration. As a result, the pressure in the first pressure chamber Ca and the pressure in the second pressure chamber Cb vary, and the micro vibration is generated in the ink in the nozzle N to such an extent that the ink is not ejected from the nozzle N.

On the other hand, when the switch SWs[m] and the switch SWt[k] are exclusively turned ON, the ejection operation by the first piezoelectric element 41a and the second piezoelectric element 41b is not performed, and the first detection signal Vout1 and the second detection signal Vout2 are supplied to the determination unit 50 via the detection circuit 46. Then, the determination unit 50 determines the liquid state of the nozzle N using the first detection signal Vout1 and the second detection signal Vout2.

Further, switches SWe and SWf are disposed between the drive controller 45 and the detection circuit 46. The switch SWe is a switch that switches between conduction (ON) and non-conduction (OFF) between the wiring line LHa for the transmission of the first drive signal ComA and the determination unit 50. The switch SWf is a switch that switches between conduction (ON) and non-conduction (OFF) between the wiring line LHb for the transmission of the second drive signal ComB and the detection circuit 46. Further, the switches SWe and SWf are electrically coupled to each other in a node N1. The switches SWe and SWf are turned ON exclusively in the state in which the detection signal Vout can be detected from the piezoelectric element 41.

In the state in which the detection signal Vout based on the residual vibration after the first drive signal ComA is supplied can be detected, the drive controller 45 sets the switch SWe to the ON state, and sets the switch SWf to the OFF state. Further, in the state in which the detection signal Vout based on the residual vibration after the second drive signal ComB is supplied can be detected, the drive controller 45 sets the switch SWf to the ON state, and sets the switch SWe to the OFF state.

### A6: Waveform Provided to Drive Signal Com

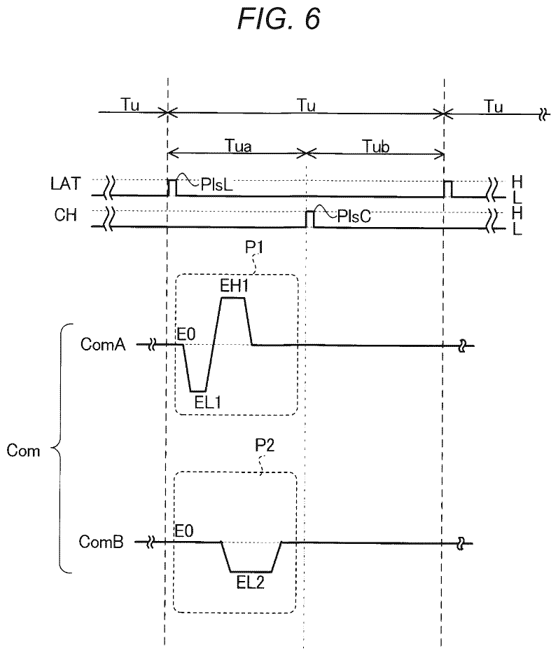

FIG. 6 is a diagram illustrating a waveform provided to the drive signal Com in the first embodiment. As shown in FIG. 6, the latch signal LAT includes a pulse PlsL for defining a repetition period Tu. The period Tu corresponds to a printing period for forming a dot on the medium 11 with the ink from the nozzle N. The period Tu is defined as, for example, a period from a rise of the pulse PlsL to the subsequent rise of the pulse PlsL. Further, the change signal CH includes a pulse PlsC for dividing the period Tu into an anterior control period Tua and a posterior control period Tub. The control period Tua is, for example, a period from the rise of the pulse PlsL to the rise of the pulse PlsC. The control period Tub is, for example, a period from the rise of the pulse PlsC to the rise of the pulse PlsL.

The first drive signal ComA includes an ejection pulse P1. The ejection pulse P1 is provided in the control period Tua. The ejection pulse P1 is a potential pulse which drives the piezoelectric element 41 so as to generate a pressure change with the intensity of ejecting the ink from the nozzle N in the pressure chamber C. When the ejection pulse P1 is supplied to the piezoelectric element 41, the ink is ejected as an ink droplet from the nozzle N. Specifically, for example, when the first drive signal ComA is simultaneously supplied to both the first piezoelectric element 41a and the second piezoelectric element 41b, the ink is ejected from the nozzle N as the ink droplet.

In the example in FIG. 6, the ejection pulse P1 has a waveform which decreases from the reference potential E0 to the lowest potential EL1 lower than the reference potential E0, then rises to the highest potential EH1 higher than the reference potential E0, and then returns to the reference potential E0. Note that the reference potential E0 is a potential higher than, for example, the offset potential VBS. Further, the potential in the control period Tub out of the first drive signal ComA is the reference potential E0.

The second drive signal ComB has a non-ejection pulse P2. The non-ejection pulse P2 is provided in the control period Tua. The non-ejection pulse P2 is a pulse which drives the piezoelectric element 41 so as to generate a pressure change with the intensity of not ejecting the ink from the nozzle N in the pressure chamber C. By supplying the non-ejection pulse P2 to the piezoelectric element 41, the micro vibration is generated in the meniscus of the ink in the nozzle N without ejecting the ink from the nozzle N. Specifically, for example, by simultaneously supplying the non-ejection pulse P2 to both the first piezoelectric element 41a and the second piezoelectric element 41b, the micro vibration is generated in the meniscus without ejecting the ink from the nozzle N.

In the example in FIG. 6, the non-ejection pulse P2 has a waveform that decreases from the reference potential E0 to the lowest potential EL2 lower than the reference potential E0 and then returns to the reference potential E0. Further, the potential of the second drive signal ComB in the control period Tub is the reference potential E0.

In a period in which the ink is not ejected from the nozzle N, accumulation of the ink in the nozzle N tends to occur. When the period becomes long, there is a possibility that an increase in viscosity of the ink in the nozzle N is incurred. Then, during the period in which the ink is not ejected from the nozzle N, the piezoelectric element 41 is driven so as to make the micro vibration of the meniscus to the extent that the ink is not ejected from the nozzle N. The micro vibration is a vibration smaller than the vibration of the meniscus when ejecting the ink. Due to this micro vibration, the ink in the nozzle N is agitated. Therefore, in cooperation with the action of the circulation flow of the ink by the circulation mechanism 26, replacement of the ink is smoothly performed between the nozzle N and the nozzle flow path Nf. Therefore, the increase in viscosity of the ink inside the nozzle N can be prevented.

Based on the print data Img, the controller 51 controls the supply of the drive signals Com to the plurality of piezoelectric elements 41 so that each of the plurality of piezoelectric elements 41 becomes one of an ejection period, a non-ejection period, and a detection signal output period for each period Tu. The ejection period is a period during which the ink is ejected from the nozzle N by supplying the ejection pulse P1 of the first drive signal ComA. The non-ejection period is a period during which the meniscus of the nozzle N vibrates although the ink is not ejected from the nozzle N by supplying the non-ejection pulse P2 of the second drive signal ComB. The detection signal output period is a period which corresponds to the control period Tub of the first drive signal ComA or the control period Tub of the second drive signal ComB, and in which the detection signal Vout representing the change of the electromotive force generated when the piezoelectric element 41 is displaced due to a pressure vibration remaining in the liquid in the pressure chamber C is transmitted to the wiring line without applying the drive signal Com to the piezoelectric element 41 to operate the piezoelectric element 41. The detection signal output period is also a period in which the determination unit 50 determines the ejection state.

Note that the drive signals Com other than the first drive signal ComA and the second drive signal ComB may be provided in addition to, or instead of the first drive signal ComA and the second drive signal ComB. For example, a drive signal Com that includes a pulse related to ejection of the ink other than the ejection pulse P1 may be provided. Further, a drive signal Com that includes a pulse related to the micro vibration of the meniscus other than the non-ejection pulse P2 may be provided. Further, for example, a drive signal Com that includes a pulse for detecting a residual vibration signal may be provided.

### A7: Ejection Operation and Detection Operation

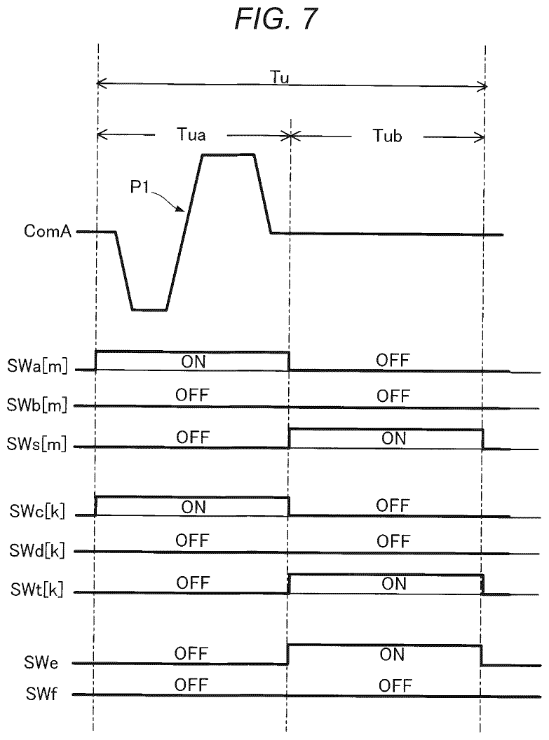

FIG. 7 is a diagram illustrating the ejection operation and the detection operation in the first embodiment. In the example in FIG. 7, the ejection operation of ejecting the ink from the nozzle N is executed in the control period Tua, and the detection operation in which the determination unit 50 detects the detection signal Vout is performed in the control period Tub. In the example in FIG. 7, the control period Tua is the ejection period, and the control period Tub is the detection signal output period.

For example, in the control period Tua, each of the switch SWa[m] and the switch SWc[k] is turned ON, and each of the switch SWb[m], the switch SWd[k], the switch SWs[m], and the switch SWt[k] is turned OFF. Further, in the control period Tua, each of the switches SWe and SWf is turned OFF.

Due to such switching of the switches SW, the ejection pulse P1 is simultaneously applied to both the first piezoelectric element 41a[m] and the second piezoelectric element 41b[k] in the control period Tua. As a result, the first piezoelectric element 41a and the second piezoelectric element 41b are driven simultaneously, and the ink is ejected from the nozzle N.

Further, for example, in the control period Tua, each of the switch SWs[m] and the switch SWt[k] is turned ON, and each of the switch SWa[m], the switch SWb[m], the switch SWc[k], and the switch SWd[k] is turned OFF. Further, in the control period Tub, the switch SWe is turned ON.

Due to such switching of the switches SW, the first detection signal Vout1 is output from the first piezoelectric element 41a[m] and the second detection signal Vout2 is output from the second piezoelectric element 41b[m]. Then, the determination unit 50 detects a change in the electromotive force of the piezoelectric element 41 in accordance with the residual vibration generated in the ink in the pressure chamber C. That is, the determination unit 50 detects the first detection signal Vout1 and the second detection signal Vout2 having passed through the detection circuit 46. The determination unit 50 determines the liquid state of the ink flowing through the individual flow path P provided to the head chip 24 using these detection signals Vout.

Note that it is possible to apply the non-ejection pulse P2 provided to the second drive signal ComB simultaneously to both the first piezoelectric element 41a[m] and the second piezoelectric element 41b[k] in the control period Tua, and detect the first detection signal Vout1 and the second detection signal Vout2 in the control period Tub. In this case, in contrast to the example in FIG. 7 described above, in the control period Tua, the switch SWb[m] and the switch SWd[k] are turned ON, and the other switches SW are turned OFF. In the control period Tub, the same as the example in FIG. 7 described above applies. In this example, the control period Tua is the non-ejection period in which the micro vibration operation is performed, and the control period Tub is the detection signal output period.

### A8: Detection Circuit 46 and Determination Unit 50

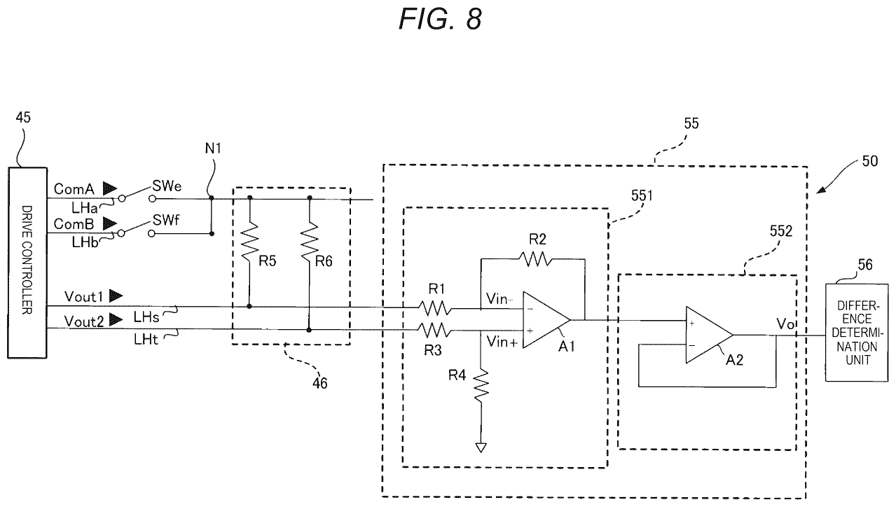

FIG. 8 is a diagram illustrating the detection circuit 46 and the determination unit 50 shown in FIG. 2. As shown in FIG. 8, the detection circuit 46 includes detecting resistors R5 and R6. A wiring line LHs for transmitting the first detection signal Vout1 is coupled to one end of the detecting resistor R5, and the other end is electrically coupled to the node N1. A wiring line LHs for transmitting the second detection signal Vout2 is coupled to one end of the detecting resistor R6, and the other end is electrically coupled to the node N1.

The detecting resistors R5 and R6 each function as a bias resistor that supplies the voltage of the drive signal Com to the voltage of the detection signal Vout. Therefore, by providing the detection circuit 46, biases are respectively applied to the first detection signal Vout1 and the second detection signal Vout2.

The determination unit 50 determines the liquid state at the nozzle N based on the difference between the first detection signal Vout1 and the second detection signal Vout2. The first detection signal Vout1 represents a change in the electromotive force of the first piezoelectric element 41a according to the residual vibration generated in the ink in the first pressure chamber Ca after at least one of the first piezoelectric element 41a and the second piezoelectric element 41b is driven. The second detection signal Vout2 represents a change in the electromotive force of the second piezoelectric element 41b according to the residual vibration generated in the ink in the second pressure chamber Cb after at least one of the first piezoelectric element 41a and the second piezoelectric element 41b is driven. Note that in the present embodiment, the first piezoelectric element 41a and the second piezoelectric element 41b are driven simultaneously.

The determination unit 50 includes a difference detector 55 and a difference determination unit 56. The first detection signal Vout1 and the second detection signal Vout2 are input to the difference detector 55. Then, the difference detector 55 outputs a determination signal Vo that is a signal related to a difference between the first detection signal Vout1 and the second detection signal Vout2.

The difference detector 55 includes a subtraction amplifier circuit 551 and a buffer circuit 552. The subtraction amplifier circuit 551 is a circuit that amplifies the difference between the first detection signal Vout1 and the second detection signal Vout2. The subtraction amplifier circuit 551 includes resistors R1, R2, R3, and R4, and an operational amplifier A1. The relationship between the resistors R1 and R3 is R1=R3, and the relationship between the resistors R2 and R4 is R2=R4. In this case, the determination signal Vo output from the difference detector 55 is expressed by the following formula.

$$Vo = R 2 / R 1 ( {V}_{in +} - {V}_{in -} )$$

Therefore, the difference detector 55 amplifies the difference between the first detection signal Vout1 and the second detection signal Vout2.

The buffer circuit 552 is, for example, a voltage follower using an operational amplifier A2.

The difference determination unit 56 determines the liquid state at the nozzle N based on the determination signal Vo, and generates determination information Stt representing the determination result. For example, when the amplitude of the determination signal Vo exceeds a threshold value, the difference determination unit 56 determines that the liquid state is defective. On the other hand, when the amplitude of the determination signal Vo is equal to or smaller than the threshold value, the difference determination unit 56 determines that the liquid state is normal.

A9: Example of Determination of Liquid state

FIG. 9 is a diagram showing the first detection signal Vout1 and the second detection signal Vout2 in a normal state. In FIG. 9, the waveform W1 of the first detection signal Vout1 in the normal state is represented by a solid line. The waveform W2 of the second detection signal Vout2 in the normal state is represented by a dotted line. As shown in FIG. 9, in the normal state, the waveform W1 of the first detection signal Vout1 and the waveform W2 of the second detection signal Vout2 are substantially equal and overlap each other.

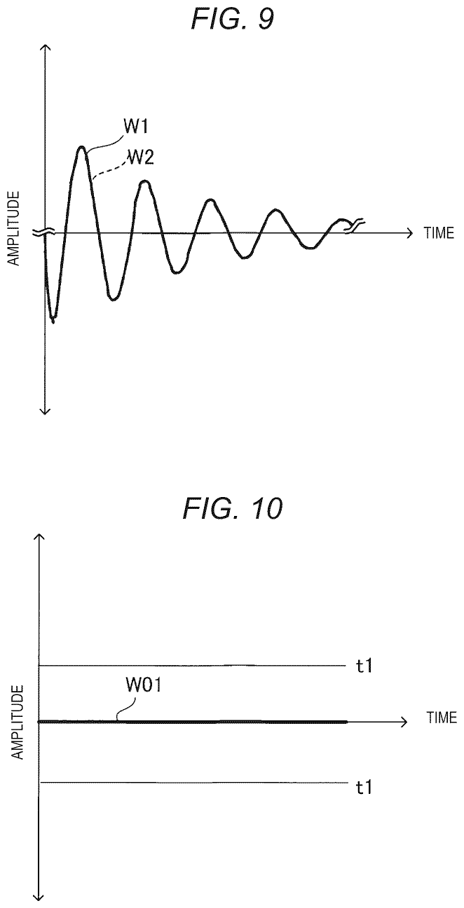

FIG. 10 is a diagram illustrating a determination signal Vo that is a signal related to a difference between the first detection signal Vout1 and the second detection signal Vout2 shown in FIG. 9. In FIG. 10, the waveform W01 of the determination signal Vo is represented by a solid line. Since the waveform W1 of the first detection signal Vout1 and the waveform W2 of the second detection signal Vout2 illustrated in FIG. 9 are substantially equal, the amplitude of the difference between the first detection signal Vout1 and the second detection signal Vout2 is substantially 0 (zero).

Further, FIG. 10 shows the threshold value t1. As described above, in the normal state, the amplitude of the difference between the first detection signal Vout1 and the second detection signal Vout2 is substantially zero. Therefore, the difference is equal to or less than the threshold value. Note that the expression that a value is equal to or less than the threshold value means that the value is equal to or less than an absolute value of the threshold value t1. When the amplitude of the determination signal Vo is equal to or smaller than the threshold value, the difference determination unit 56 determines that the liquid state is normal.

FIG. 11 is a diagram illustrating the first detection signal Vout1 and the second detection signal Vout2 in an abnormal state. In FIG. 11, the waveform W3 of the first detection signal Vout1 in the abnormal state is represented by a solid line. The waveform W4 of the second detection signal Vout2 in the abnormal state is represented by a dotted line.

As shown in FIG. 11, in the abnormal state, the waveform W3 of the first detection signal Vout1 and the waveform W4 of the second detection signal Vout2 are different from each other. When there is an abnormality in the liquid state, the first piezoelectric element 41a and the second piezoelectric element 41b show the respective waveforms different from each other. For example, as shown in FIG. 11, the waveform W3 of the first detection signal Vout1 and the waveform W4 of the second detection signal Vout2 are different from each other.

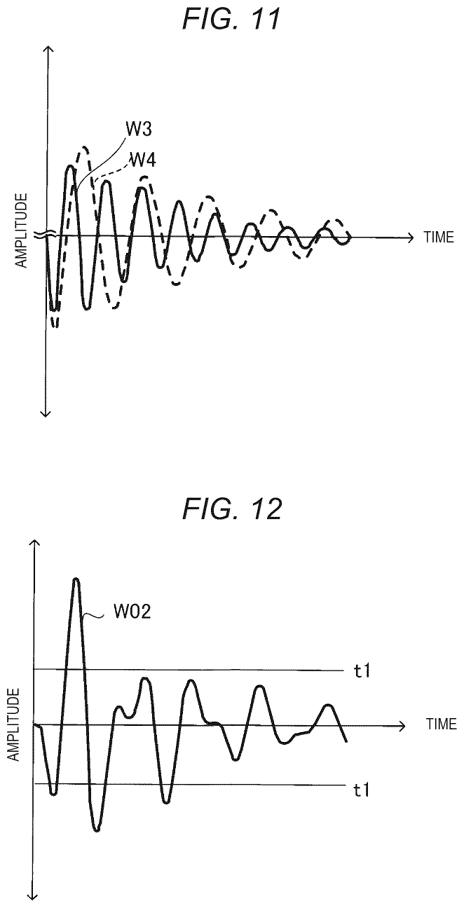

FIG. 12 is diagram a illustrating a determination signal Vo that is a signal related to the difference between the first detection signal Vout1 and the second detection signal Vout2 shown in FIG. 11. In FIG. 12, the waveform W02 of the determination signal Vo is represented by a solid line. Since the waveform W3 of the first detection signal Vout1 and the waveform W4 of the second detection signal Vout2 shown in FIG. 11 are different from each other, the amplitude of the difference between the first detection signal Vout1 and the second detection signal Vout2 shows the waveform W02 shown in FIG. 12. In FIG. 12, the amplitude of the waveform W02 has a portion exceeding the threshold value t1. When the amplitude of the determination signal Vo exceeds the threshold value t1, the difference determination unit 56 determines that the liquid state is abnormal.

As is understood from FIG. 10 and FIG. 12, it is possible to easily and quickly determine the liquid state at the nozzle N by determining whether the determination signal Vo based on the difference between the first detection signal Vout1 and the second detection signal Vout2 is within the threshold value t1. Therefore, the abnormality can be determined immediately.

As described above, the determination unit 50 in the present embodiment determines the liquid state at the nozzle N based on the difference between the first detection signal Vout1 and the second detection signal Vout2. By providing the determination unit 50, in the configuration in which the plurality of pressure chambers C, namely the first pressure chamber Ca and the second pressure chamber Cb, is provided for each of the nozzles N, it is possible to immediately determine whether the liquid state is abnormal.

In addition, by driving the first piezoelectric element 41a and the second piezoelectric element 41b using the same drive signal Com, it is unnecessary to determine which one of the first drive signal ComA and the second drive signal ComB is supplied to generate the residual vibration corresponding to each of the first detection signal Vout1 and the second detection signal Vout2. Since the determination is made based on the difference between the first detection signal Vout1 and the second detection signal Vout2, it is possible to immediately and simply make the determination even when any drive signal is supplied to the first piezoelectric element 41a and the second piezoelectric element 41b.

Further, in the present embodiment, the natural vibration period of the flow path Nfa from the first pressure chamber Ca to the nozzle N is equal to the natural vibration period of the flow path Nfb from the second pressure chamber Cb to the nozzle N. When the head chip 24 is configured such that the natural vibration frequency becomes equal between the flow path Nfa and the flow path Nfb, the amplitude of the signal of the difference between the first detection signal Vout1 and the second detection signal Vout2 in the normal state is 0 (zero) or is approximately 0 (zero) as described above. Therefore, it is possible to easily and accurately determine whether the liquid state is abnormal. Note that the expression that the flow path Nfa and the flow path Nfb are equal in the natural vibration frequency to each other includes when they are assumed to be equal to each other in consideration of measurement tolerance in addition to when they are completely equal to each other.

Further, as described above, the determination unit 50 includes the difference detector 55 that outputs the determination signal Vo that is a signal related to the difference between the first detection signal Vout1 and the second detection Vout2, signal and the difference determination unit 56 that determines the liquid state based on whether the level of the determination signal Vo is within the threshold value t1. Therefore, it is possible to easily determine the presence or absence of abnormality in the ejection state with a simple configuration in which the difference determination unit 56 determines whether the difference between the first detection signal Vout1 and the second detection signal Vout2 is within the threshold value t1.

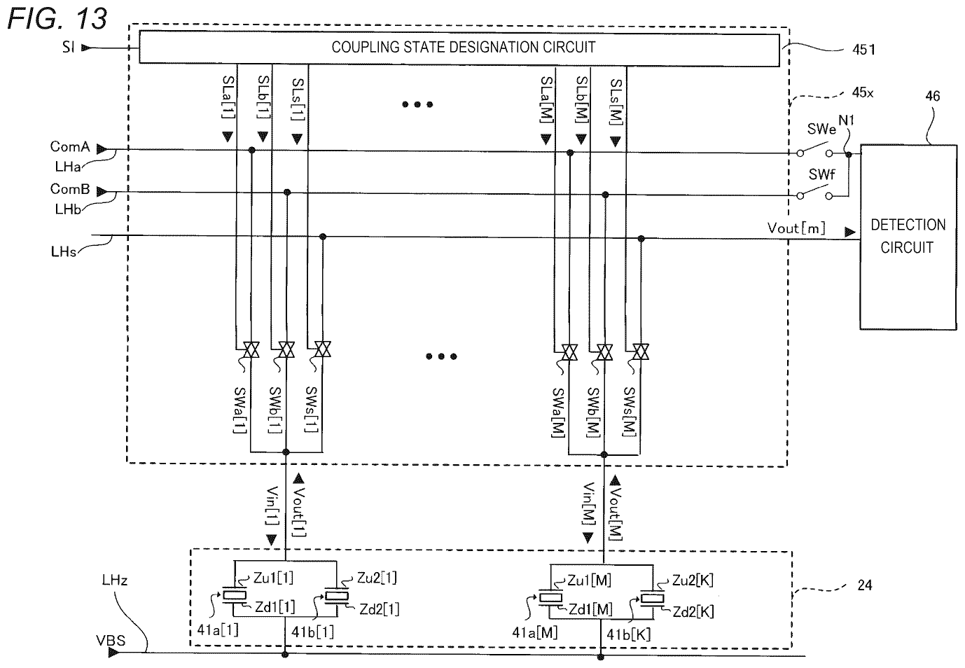

FIG. 13 is a diagram illustrating a configuration example of a drive controller 45x in a comparative example. In the present embodiment, the first piezoelectric element 41a and the second piezoelectric element 41b are electrically coupled respectively to the wiring line LHs and the wiring line LHt for transmitting the detection signal Vout separated from each other, while in the comparative example shown in FIG. 13, the first piezoelectric element 41a and the second piezoelectric element 41b are electrically coupled to the same wiring line LHs for transmitting the detection signal Vout. Therefore, in the comparative example, a signal in which the first detection signal Vout1 and the second detection signal Vout2 are added together is input to the determination unit 50.

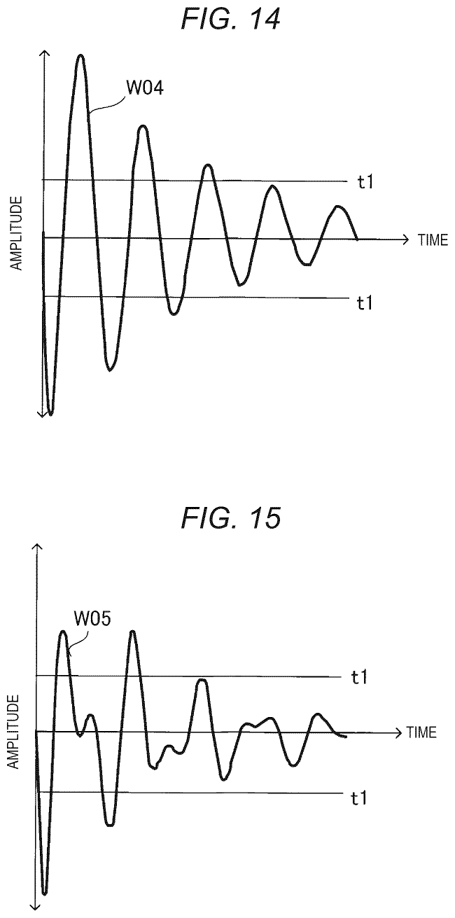

FIG. 14 is a diagram illustrating a determination signal Vo in the comparative example in a normal state. FIG. 14 illustrates a waveform W04 of the determination signal Vo in the comparative example, which is a signal obtained by adding the first detection signal Vout1 and the second detection signal Vout2 shown in FIG. 9. When the first detection signal Vout1 and the second detection signal Vout2 are added together, the amplitude of the waveform W04 in FIG. 14 is larger than the amplitude of the waveform W1 and the amplitude of the waveform W2 in FIG. 9.

FIG. 15 is a diagram illustrating a determination signal Vo in the comparative example in the abnormal state. FIG. 15 illustrates a waveform W05 of the determination signal Vo in the comparative example, which is the signal obtained by adding the first detection signal Vout1 and the second detection signal Vout2 shown in FIG. 11.

In the comparative example, in both of the normal case and the abnormal case, the threshold value t1 is exceeded. For this reason, in the comparative example, it is necessary to specify a parameter that is a feature for discriminating the normal state and the abnormal state from each other. For example, the amplitude or the period of the determination signal Vo can be used as the parameter that is a feature for the discrimination. In order to acquire the parameters, a detection time equal to or longer than one vibration cycle of the determination signal Vo is required. Further, when the waveform of the drive signal Com changes, the amplitude value of the determination signal Vo also changes. Therefore, it is necessary to determine what drive signal Com is supplied to generate the residual vibration corresponding to each of the waveforms W04 and W05. Further, in the comparative example, since the waveform of the determination signal Vo corresponds to the signal obtained by adding the first detection signal Vout1 and the second detection signal Vout2, the change of the signal is complicated, and it is difficult to immediately determine the liquid state.

In contrast, in the present embodiment, the first piezoelectric element 41a and the second piezoelectric element 41b are coupled respectively to the wiring lines for transmitting the detection signals Vout different from each other. Specifically, the first piezoelectric element 41a is electrically coupled to the wiring line LHs, and the second piezoelectric element 41b is electrically coupled to the wiring line LHt. In this way, since the first piezoelectric element 41a and the second piezoelectric element 41b are coupled to the wiring lines for transmitting the detection signals Vout different from each other, the first detection signal Vout1 and the second detection signal Vout2 can be detected as the respective signals different from each other. Accordingly, it is possible to immediately determine the liquid state as described above, based on the difference between the first detection signal Vout1 and the second detection signal Vout2 detected at the same time or in parallel, even in a period shorter than one vibration cycle of the detection signal.

Further, in the present embodiment, as described above, the drive controller 45 simultaneously supplies the drive signal Com to the first piezoelectric element 41a and the second piezoelectric element 41b. Further, the first detection signal Vout1 and the second detection signal Vout2 are simultaneously input to the determination unit 50. Therefore, it is possible to immediately and accurately determine the liquid state based on the first detection signal Vout1 and the second detection signal Vout2 detected at the same time.

Further, in the above description, the liquid state is determined based on the residual vibration after the ejection pulse P1 of the first drive signal ComA is supplied to the first piezoelectric element 41a and the second piezoelectric element 41b. However, the liquid state may be determined based on the residual vibration after the non-ejection pulse P2 of the second drive signal ComB is supplied to both the first piezoelectric element 41a and the second piezoelectric element 41b. Further, the liquid state may be determined based on the residual vibration after a pulse of a drive signal Com other than the first drive signal ComA and the second drive signal ComB is applied. Even in these cases, the liquid state at the nozzle N is determined based on the difference between the first detection signal Vout1 and the second detection signal Vout2 detected after the first piezoelectric element 41a and the second piezoelectric element 41b are driven with the same pulse. Therefore, it is possible to easily and immediately determine the liquid state.

### 2. Second Embodiment

In the aspects hereinafter exemplified, regarding the elements having substantially the same operations and functions as in the first embodiment described above, the reference numerals and signs used in the description of the first embodiment described above are diverted thereto to thereby omit the detailed description thereof as appropriate.

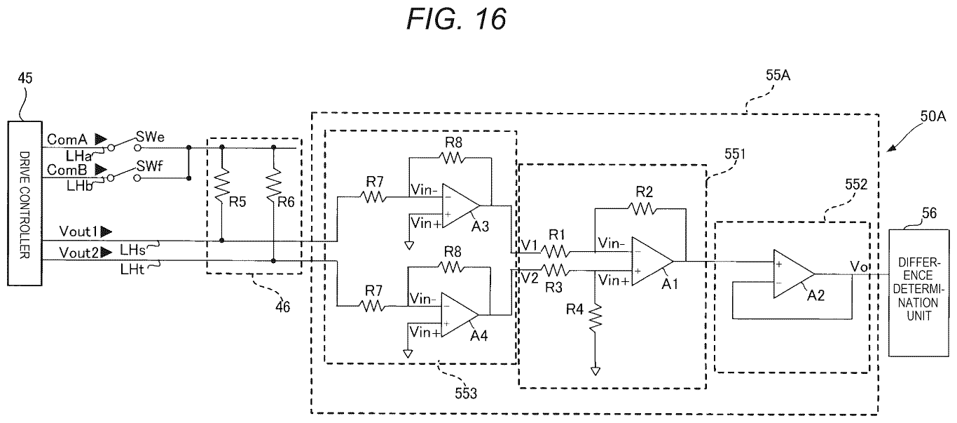

FIG. 16 is a diagram showing a determination unit 50A in a second embodiment. As shown in FIG. 16, a difference detector 55A of the determination unit 50A in the present embodiment further includes an amplifier circuit 553. The amplifier circuit 553 is provided between the detection circuit 46 and the subtraction amplifier circuit 551. The amplifier circuit 553 amplifies the amplitude of the first detection signal Vout1 and the amplitude of the second detection signal Vout2. The amplifier circuit 553 includes resistors R7, R8, and operational amplifiers A3 and A4. In the amplifier circuit 553, when the first detection signal Vout1 and the second detection signal Vout2 are set to input signals, and a first output signal V1 and a second output signal V2 are defined as output signals, the output signals are expressed by the following formulas.

$$V 1 = ( R 7 / R 8 ) Vout 1$$

$$V 2 = ( R 7 / R 8 ) Vout 2$$

In the present embodiment, as described above, the determination unit 50A includes the amplifier circuit 553 that amplifies the amplitudes of both the first detection signal Vout1 and the second detection signal Vout2. By providing such an amplifier circuit 553, even when there is a difference in amplitude between the first detection signal Vout1 and the second detection signal Vout2 in the normal state due to the flow path structure and so on, the signals can be adjusted so as to reduce the difference between the amplitudes of the first output signal V1 and the second output signal V2 used for the determination in the normal state. Therefore, even in the case of the flow path structure in which there is a difference in amplitude between the first detection signal Vout1 and the second detection signal Vout2 in the normal state, the determination of the liquid state can be made immediately and with high accuracy using the difference between the first output signal V1 and the second output signal V2 adjusted in amplitude.

Note that the amplifier circuit 553 amplifies the amplitudes of both the first detection signal Vout1 and the second detection signal Vout2 in the present embodiment, but it is possible to amplify either one thereof so as to coincide with the other thereof.

### 3. Third Embodiment

In the aspects hereinafter exemplified, regarding the elements having substantially the same operations and functions as in the first embodiment described above, the reference numerals and signs used in the description of the first embodiment described above are diverted thereto to thereby omit the detailed description thereof as appropriate.

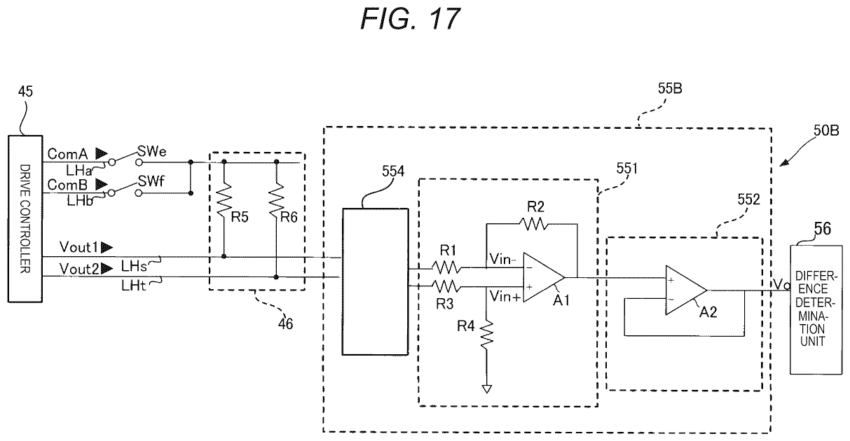

FIG. 17 is a diagram showing a determination unit 50B in a third embodiment. As illustrated in FIG. 17, a difference detector 55B of the determination unit 50B in the present embodiment further includes a phase delay circuit 554. The phase delay circuit 554 is disposed between the detection circuit 46 and the subtraction amplifier circuit 551. The phase delay circuit 554 is a circuit that delays the phase of at least one of the first detection signal Vout1 and the second detection signal Vout2 to match the phase of the first detection signal Vout1 with the phase of the second detection signal Vout2.

In the first embodiment, the first detection signal Vout1 and the second detection signal Vout2 are simultaneously input to the determination unit 50, and the phase of the first detection signal Vout1 and the phase of the second detection signal Vout2 coincide with each other. In contrast, for example, there is when the first detection signal Vout1 and the second detection signal Vout2 are not simultaneously input to the determination unit 50, or when the phase of the first detection signal Vout1 and the phase of the second detection signal Vout2 are shifted from each other due to the influence of the structure or the circuit. In this case, the phase of the first detection signal Vout1 is different from the phase of the second detection signal Vout2, and a difference occurs between the first detection signal Vout1 and the second detection signal Vout2 even when the liquid state is normal. Even in this case, since the phase delay circuit 554 that adjusts the phases of the first detection signal Vout1 and the second detection signal Vout2 is provided, the difference between the first detection signal Vout1 and the second detection signal Vout2 can be made equal to or smaller than the threshold value in the normal state. Accordingly, it is possible to immediately and accurately determine the liquid state using the difference between the first detection signal Vout1 and the second detection signal Vout2.

### 4. Fourth Embodiment

In the aspects hereinafter exemplified, regarding the elements having substantially the same operations and functions as in the first embodiment described above, the reference numerals and signs used in the description of the first embodiment described above are diverted thereto to thereby omit the detailed description thereof as appropriate.

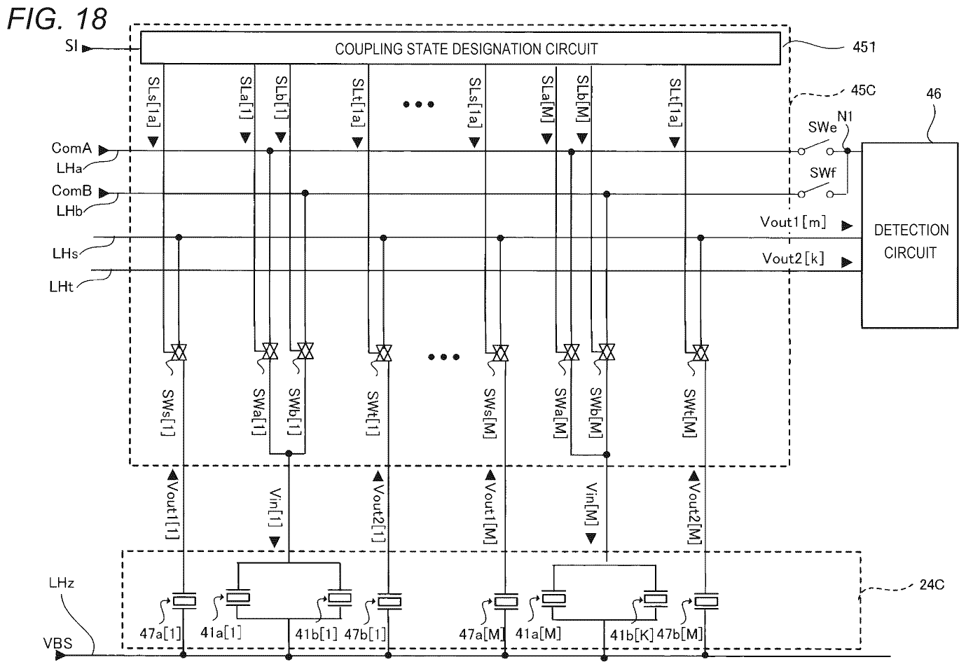

FIG. 18 is a diagram illustrating a configuration example of a drive controller 45C and a head chip 24C in a fourth embodiment. As illustrated in FIG. 18, the head chip 24C in the present embodiment includes a first detecting piezoelectric element 47a and a second detecting piezoelectric element 47b, separately e first piezoelectric element 41a and the second piezoelectric element 41b. The first detecting piezoelectric element 47a detects the vibration of the ink in the first pressure chamber Ca. The second detecting piezoelectric element 47b detects the vibration of the ink in the second pressure chamber Cb.

The first piezoelectric element 41a corresponds to a “first driving piezoelectric element.” The second piezoelectric element 41b corresponds to a “second driving piezoelectric element.” In the ejection period or the non-ejection period, the first piezoelectric element 41a and the second piezoelectric element 41b are driven by the drive signal Com to generate pressure variation with the intensity of ejecting the ink from the nozzle N in the pressure chamber C, or generate pressure variation with the intensity of not ejecting the ink from the nozzle N in the pressure chamber C. In the detection signal output period, a detection signal Vout representing a change in electromotive force generated when the first detecting piezoelectric element 47a and the second detecting piezoelectric element 47b are displaced is transmitted through the wiring line.

As shown in FIG. 18, the first detecting piezoelectric element 47a and the second detecting piezoelectric element 47b are electrically coupled to the wiring lines for transmitting detection signals Vout transmission lines different from each other. Therefore, similarly to the first embodiment, the determination unit 50 determines the liquid state at the nozzle N based on the difference between the first detection signal Vout1 and the second detection signal Vout2. By providing the determination unit 50, in the configuration in which the plurality of pressure chambers C, namely the first pressure chamber Ca and the second pressure chamber Cb, is provided for each of the nozzles N, it is possible to immediately determine whether the liquid state is abnormal.

Further, although not shown in detail in the drawing, the first detecting piezoelectric element 47a overlaps the first pressure chamber Ca in a plan view and is disposed on a surface facing to the Z1 direction of the vibrating plate 35. The first detecting piezoelectric element 47a is disposed adjacent to the first piezoelectric element 41a. Similarly, the second detecting piezoelectric element 47b overlaps the second pressure chamber Cb in a plan view, and is disposed on a surface facing to the Z1 direction of the vibrating plate 35. The second detecting piezoelectric element 47b is disposed adjacent to the second piezoelectric element 41b. Each of the first detecting piezoelectric element 47a and the second detecting piezoelectric element 47b is configured by stacking two electrodes opposed to each other and a piezoelectric layer disposed between the two electrodes.

The rigidity of first detecting the piezoelectric element 47a is preferably higher than the rigidity of the first piezoelectric element 41a. Similarly, the rigidity of the second detecting piezoelectric element 47b is preferably higher than the rigidity of the second piezoelectric element 41b. By adopting such a relationship of rigidity, it is possible to suppress the possibility that the natural vibration period of the flow path Nfa is elongated by providing the first detecting piezoelectric element 47a, and thus, the frequency of driving of the first piezoelectric element 41a lowers. Similarly, it is possible to suppress the possibility that the natural vibration period of the flow path Nfb is elongated by providing the second detecting piezoelectric element 47b, and thus, the frequency of driving of the second piezoelectric element 41b lowers. Note that by increasing the rigidity of the first detecting piezoelectric element 47a and the second detecting piezoelectric element 47b, the displacement due to the residual vibration becomes small, and the amplitude of the detection signal Vout also becomes small, and therefore, it is also possible to increase the accuracy of the determination of the liquid state using the difference by appropriately amplifying the detection signal Vout.

### 5. Modified Examples

The embodiments exemplified hereinabove can variously be modified. Specific aspects of the modifications applicable to the embodiments described above will be exemplified below. The aspects randomly selected from the following exemplifications can be combined as appropriate within a range in which no mutual confliction exists.

### 5A. First Modified Example

For example, the first detection signal Vout1 and the second detection signal Vout2 may be stored in the storage unit 52, and the determination of the liquid state may be made based on the first detection signal Vout1 and the second detection signal Vout2 stored in the storage unit 52.

Specifically, the drive controller 45 supplies the drive signal Com only to one of the first piezoelectric element 41a and the second piezoelectric element 41b. After the drive signal Com is supplied only to one thereof, the storage unit 52 stores the first detection signal Vout1. Similarly, the drive controller 45 supplies the drive signal Com only to the other of the first piezoelectric element 41a and the second piezoelectric element 41b. After the drive signal Com is supplied only to the other, the storage unit 52 stores the second detection signal Vout2. The determination unit 50 determines the liquid state at the nozzle N based on the difference between the first detection signal Vout1 stored in the storage unit 52 and the second detection signal Vout2 stored in the storage unit 52.

By storing the detection signal Vout in the storage unit 52 in advance, for example, when it is necessary to determine the liquid state, the liquid state at the nozzle N can be immediately determined.

### 5B. Other Modified Examples

In the embodiments described above, the configuration in which the ink used in the liquid ejection head is circulated by the circulation mechanism is exemplified, but this configuration is not a limitation, and it is possible to adopt a configuration which does not include such a mechanism for the circulation.

In the embodiments described above, the serial type liquid ejection apparatus 100 in which the carriage 231 with the head chip 24 mounted thereon is reciprocated is exemplified, but the present disclosure can be applied to a line type liquid ejection apparatus in which the plurality of nozzles N is distributed over the entire width of the medium 11.

The liquid ejection apparatus 100 exemplified in the above embodiments may be adopted in various apparatuses such as a facsimile apparatus and a copier in addition to apparatuses dedicated for printing in addition to an apparatus dedicated to printing, and the application of the present disclosure is not particularly limited. However, the usage of the liquid ejection apparatus is not limited to printing. For example, the liquid ejection apparatus for ejecting a solution of a coloring material is used as a manufacturing apparatus for forming a color filter of a display apparatus such as a liquid crystal display panel. Further, the liquid ejection apparatus that jets a solution of a conductive material is used as a manufacturing apparatus that forms wiring lines and electrodes of a wiring board. Further, a liquid ejection apparatus for ejecting a solution of an organic substance related to a living body is used as, for example, a manufacturing apparatus for manufacturing a biochip.

What is claimed is:

1. A liquid ejection apparatus comprising:
a first piezoelectric element driven by a drive signal;
a first pressure chamber a volume of which changes in accordance with displacement of the first piezoelectric element;
a second piezoelectric element driven by the drive signal;
a second pressure chamber a volume of which changes in accordance with displacement of the second piezoelectric element;
a nozzle flow path which communicates with the first pressure chamber and the second pressure chamber and which is provided with a nozzle configured to eject a liquid; and
a determination unit configured to determine a liquid state at the nozzle based on a difference between a first detection signal which represents a change in electromotive force of the first piezoelectric element in accordance with a residual vibration generated in the liquid in the first pressure chamber after at least one of the first piezoelectric element and the second piezoelectric element is driven, and a second detection signal which represents a change in electromotive force of the second piezoelectric element in accordance with a residual vibration generated in the liquid in the second pressure chamber after at least another of the first piezoelectric element and the second piezoelectric element is driven.

2. The liquid ejection apparatus according to claim 1, wherein
a natural vibration period of a flow path from the first pressure chamber to the nozzle is equal to a natural vibration period of a flow path from the second pressure chamber to the nozzle.

3. The liquid ejection apparatus according to claim 1, wherein
the determination unit includes a difference detector to which the first detection signal and the second detection signal are input, and which is configured to output a signal related to a difference between the first detection signal and the second detection signal, and
a difference determination unit configured to determine the liquid state at the nozzle based on whether a level of the signal related to the difference is within a threshold value.

4. The liquid ejection apparatus according to claim 3, further comprising:
a drive controller configured to control supply of the drive signal to the first piezoelectric element and the second piezoelectric element, wherein
the drive controller is configured to simultaneously supply the drive signal to the first piezoelectric element and the second piezoelectric element, and
the first detection signal and the second detection signal are simultaneously input to the difference detector.

5. The liquid ejection apparatus according to claim 3, wherein
the difference detector includes an amplifier circuit configured to amplify an amplitude of at least one of the first detection signal and the second detection signal.

6. The liquid ejection apparatus according to claim 3, wherein
the difference detector includes a phase delay circuit configured to delay a phase of at least one of the first detection signal and the second detection signal to make the first detection signal and the second detection signal coincide in phase with each other.

7. The liquid ejection apparatus according to claim 1, further comprising:
a drive controller configured to control supply of the drive signal to the first piezoelectric element and the second piezoelectric element; and
a storage unit configured to store the first detection signal and the second detection signal, wherein
the drive controller supplies the drive signal only to one of the first piezoelectric element and the second piezoelectric element,
the storage unit stores the first detection signal in accordance with a residual vibration generated in the liquid in the first pressure chamber after the drive signal is supplied only to one of the first piezoelectric element and the second piezoelectric element,
the drive controller supplies the drive signal only to another of the first piezoelectric element and the second piezoelectric element,
the storage unit stores the second detection signal in accordance with a residual vibration generated in the liquid in the second pressure chamber after the drive signal is supplied only to the other of the first piezoelectric element and the second piezoelectric element, and
the determination unit determines the liquid state at the nozzle based on the difference between the first detection signal stored in the storage unit and the second detection signal stored in the storage unit.

8. A liquid ejection apparatus comprising:
a first driving piezoelectric element driven by a drive signal;
a first pressure chamber a volume of which changes in accordance with displacement of the first driving piezoelectric element;
a first detecting piezoelectric element configured to detect a vibration of a liquid in the first pressure chamber;
a second driving piezoelectric element which is driven by the drive signal;
a second pressure chamber a volume of which changes in accordance with displacement of the second piezoelectric element;
a second detecting piezoelectric element configured to detect a vibration of the liquid in the second pressure chamber;
a nozzle flow path which communicates with the first pressure chamber and the second pressure chamber and which is provided with a nozzle configured to eject the liquid; and
a determination unit configured to determine a liquid state at the nozzle based on a difference between a first detection signal which represents a change in electromotive force of the first detecting piezoelectric element in accordance with a residual vibration generated in the liquid in the first pressure chamber after at least one of the first driving piezoelectric element and the second driving piezoelectric element is driven, and a second detection signal which represents a change in electromotive force of the second detecting piezoelectric element in accordance with a residual vibration generated in the liquid in the second pressure chamber after at least another of the first driving piezoelectric element and the second driving piezoelectric element is driven.

9. The liquid ejection apparatus according to claim 8, wherein
rigidity of the first detecting piezoelectric element is higher than rigidity of the first driving piezoelectric element, and
rigidity of the second detecting piezoelectric element is higher than rigidity of the second driving piezoelectric element.
